(19) United States
(12) Patent Application Publication
(10) Pub. No.: US 2026/0301642 A1
(43) Pub. Date: Oct. 1, 2026

(54) SYSTEM OF CALIBRATING A DISPLAY

(71) Applicant: X-RITE, INCORPORATED, Grand Rapids, MI (US)

(72) Inventors: EDWARD HATTENBERGER, GRAND RAPIDS, MI (US); JAMES VOGH, GRAND RAPIDS, MI (US)

(21) Appl. No.: 19/476,992

(22) PCT Filed: Apr. 22, 2024
(86) PCT No.: PCT/US2024/025695

§ 371 Date: Oct. 20, 2025

(30) Foreign Application Priority Data
Apr. 21, 2023 (EP) 23169300.3

(51) Int. Cl. G09G 3/20

(52) U.S. Cl. CPC G09G 3/2096; G09G 2320/0666; G09G 2320/0693; G09G 2370/04; G09G 2370/06

(57) ABSTRACT

A system of calibrating a display associated with a computing device, comprises a mobile app installed on a mobile device; a web app installed on a network accessible computer; and a local app installed on the computing device. The mobile app causes the mobile device to: process an image taken of the display to determine color values of calibration patches displayed on the display; and transmit the color values and to the web app. The web app causes the server to: receive color values transmitted by the mobile app; process the color values to create a calibrated device profile for the display; and download the calibrated device profile to the local app on the computing device. The local app causes the local computer to: display color patches; receive a calibrated device profile from the web app; and install the calibrated device profile.

### BACKGROUND

Dedicated display colorimeters for measuring displays are known and used for accurate display characterization and calibration. However, in many cases such instruments are not used due to lack of access, expense, etcetera.

It has also been proposed to use mobile devices having a built-in color camera to measure color. However, various mobile devices have different color image sensors, optical geometry, and image processing firmware and software. This presents challenges to color accuracy and measurement repeatability. Also, the fixed-focus nature of mobile devices typically precludes contact measurements, allowing ambient light to affect color measurements.

What is needed is a solution using commonly available hardware for measurement, yet yielding accurate, repeatable calibration measurements.

### SUMMARY

A system of calibrating a display associated with a computing device, comprises a mobile app installed on a mobile device comprising a camera, a processor, non-volatile storage, and communication means; a web app installed on a network accessible computer; and a local app installed on the computing device. The mobile app comprises computer-readable instructions stored in the non-volatile storage that, when executed by the processor, cause the mobile device to: process an image taken of the display to determine color values of calibration patches displayed on the display; and transmit the color values and to the web app. The web app comprises a database of mobile device characterization data and computer-readable instructions that, when executed by the network accessible server, cause the server to: receive color values transmitted by the mobile app; process the color values to create a calibrated device profile for the display; and download the calibrated device profile to the local app on the computing device. The local app comprises computer-readable instructions that, when executed by a processor on the local computer, cause the local computer to: display calibration patches; receive a calibrated device profile from the web app; and install the calibrated device profile. The calibration patches comprise a plurality of red patches displayed at different levels of color saturation, a plurality of green patches displayed at different levels of color saturation, and a plurality of blue patches displayed at different levels of color saturation.

In some embodiments, the system the local app further comprises instructions which cause the local computer to display a digital color calibration card on the display; the mobile app further comprises instructions which cause the mobile device to acquire an image of the displayed digital color calibration card and send the image to the web app; and the web app further comprises instructions to calculate color differences between the displayed color calibration card and reference color information.

The system may further comprise a physical color calibration card, wherein the mobile app further comprises instructions that, when executed, cause the processor to process an image taken of the color calibration card and determine a quality of viewing conditions.

The mobile app may further comprise instructions that, when executed, cause the processor to retrieve camera calibration information specific to the mobile device from the web app.

The local app may further comprise instructions to load a predetermined device profile prior to displaying the color patches and grey scale patches.

In some embodiments, the predetermined device profile is a generic ICC profile. In some embodiments, the predetermined device profile is a manufacturer's ICC profile specific to the model of device being calibrated.

In some embodiments the calibration patches comprise red, blue and green patches. In some embodiments, the computer-readable instructions of the local app further comprise instructions that cause the local computer to display grey scale patches and the mobile app acquires an image including color patches and grey scale patches.

In some embodiments, the calibration patches consist essentially of the plurality of red patches displayed at different levels of color saturation, the plurality of green patches displayed at different levels of color saturation, the plurality of blue patches displayed at different levels of color saturation, and the grey scale patches.

In some embodiments the calibration patches comprise a first set patches comprising white patches, a second set patches comprising black patches, and a third set patches comprising red, blue and green patches. The mobile app comprises computer-readable instructions that, when executed by the processor, cause the mobile device to process images of the first set of patches, the second set of patches, and the third set of patches taken of the display to determine color values of calibration patches displayed on the display. This enables correction of spatial non-uniformity of a display (all white) and reflection correction (all black).

### BRIEF DESCRIPTION OF THE DRAWINGS

FIG. 1 is a diagram of an ambient viewing check workflow according to an aspect of the invention.

FIG. 2 is a diagram of a display device calibration workflow according to another aspect of the invention.

FIG. 3 is a diagram of a calibration verification workflow according to another aspect of the invention.

FIG. 4 is a block diagram of devices used according to another aspect of the invention.

FIG. 5 is an illustration of color and greyscale calibration patches according to another aspect of the invention.

FIG. 6 is an illustration of white calibration patches according to another aspect of the invention.

FIG. 7 is an illustration of black calibration patches according to another aspect of the invention.

### DETAILED DESCRIPTION

The term “computer” or “computing device” refers to any device that can be instructed to carry out sequences of arithmetic or logical operations automatically via a program. Without limitation, a computer can take the form of a desktop computer with an associated display, a notebook computer, a tablet computer, a smartphone, a programmable digital signal processor etc. A computer generally includes at least one processor and at least one memory device. A computer may be a subunit of another device, such as an appearance capture device. A computer may configured to establish a wired or wireless connection to another computer, including a computer for querying a database. A computer can be configured to be coupled to a data input device like a keyboard or a computer mouse or to a data output device like a display or a printer via a wired or wireless connection.

A “mobile device” refers to, for example, a hand-held smartphone or tablet computer including a color camera and communication means, a mobile phone comprising multiple light sources, a tablet computer, a mobile device with a separate plugin camera accessory, a mobile device with separate plugin light accessories, or a mobile device with a plugin camera accessory with lights, or any combination thereof. Communication means includes, but is not limited to, wireless communication transceivers, such as cellular transceivers (e.g., UTMS, HSDPS, LTE, LTE-M, 5G NR) and Wi Fi transceivers (e.g., IEEE 802.11-compliant radios) and Bluetooth transceivers. Examples of mobile devices include devices operating iOS or Android operating systems.

“Color camera,” as used herein, refers to an imaging device, such as an RGB camera. While a typical color camera has a minimum of 3 different channels (e.g. red, blue green), additional channels may be included.

A “computer system” is to be broadly understood as encompassing one or more computers. If the computer system comprises more than one computer, these computers do not necessarily need to be at the same location. The computers within a computer system may communicate with one another via wired or wireless connections.

A “processor” is an electronic circuit which performs operations on an external data source, in particular, a memory device.

A “memory device” or briefly “memory” is a device that is used to store information for use by the processor. The memory device may include volatile memory, as for random-access memory (RAM), and nonvolatile memory, as for read-only memory (ROM). In some embodiments, the memory device may include a non-volatile semiconductor memory device such as an (E) EPROM or a flash memory device, which may take the form of, e.g., a memory card or a solid-state disk. In some embodiments, the memory device may include a mass storage device having mechanical components, like a hard disk. The memory device can store a program for execution by the processor. A non-volatile memory device may also be called a non-volatile computer-readable medium.

A “program”, “application” or “app” is a collection of instructions that can be executed by processor to perform a specific task.

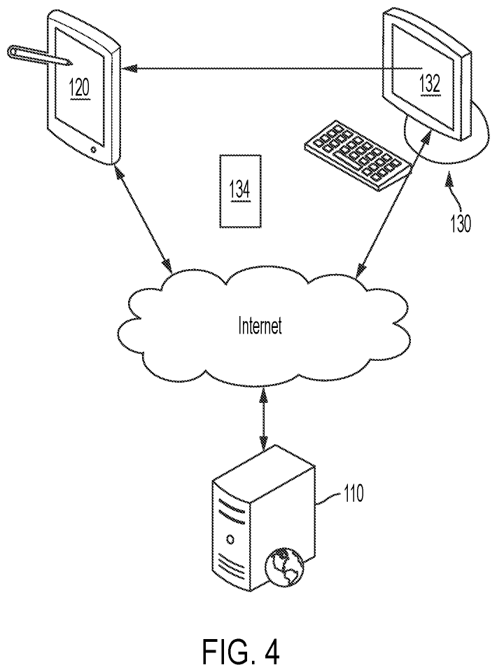

With reference to FIG. 4, an embodiment of the invention 100 comprises a server 110 hosting a database of color acquisition characterizations of mobile devices, such as smartphones with built-in cameras, a mobile app to run on a mobile device 120, and a local app installed on a computing device 130 having a monitor or display 132 to be calibrated. In some embodiments, a physical color reference card 134 is included.

The characterization data in the database may be compiled in conventional fashion for devices on which the mobile app is intended to be installed and run. For example, camera characterization for mobile smartphone cameras may be compiled and made available. In some embodiments, display characterization data may also be compiled and made available to give more accurate results.

The color reference card comprises an array of color reference patches. The spectral information for each color reference patch is known and stored in the system, for example, either in the mobile device as part of the mobile app or on the server host. In some embodiments, a QR code is provided on the color reference card and when an image of the color reference card is acquired, the mobile app accesses the server and retrieves reference spectral information corresponding to the color reference card in the image.

Non-planar target elements may be included for estimation of light direction may comprise a partially spherical element or a multi-planar element having surfaces that are not parallel to the substrate of the color reference cards. See, for example, U.S. Pat. Pub. No. 2016/0224861, the entirety of which is incorporated by reference.

The mobile app contains instructions which, when executed by the mobile device, performs or assists in performing steps as set forth in the following workflows. In some embodiments, all of the workflows are performed to calibrate a display device. In some embodiments, each of the following workflows may be performed in stand-alone fashion.

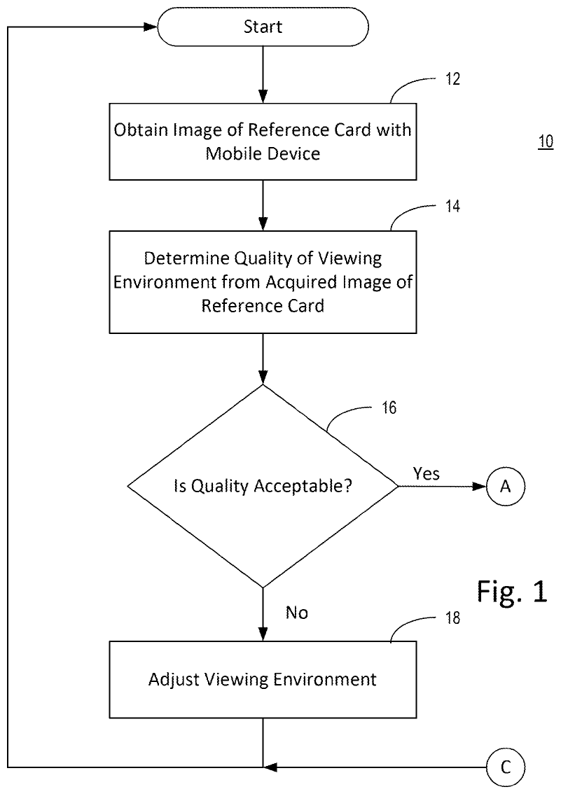

With reference to FIG. 1, in a first workflow 10, an ambient viewing check is performed. In a first step 12, a measurement is made of a color calibration card using the mobile device. The measurement may comprise acquiring an image of the color calibration card in proximity of the display to be calibrated so that the conditions of the viewing environment can be characterized.

In a second step 14, the quality of the viewing environment is determined by comparing previously-determined and known color or spectral values of the card to measured color or spectral values derived from the image. In some embodiments, the mobile app communicates the acquired image to a web app hosted on the server with a request for processing. The image includes metadata identifying the type of mobile device that acquired the image, which may be extracted by the web app. Alternatively, identifying information may be provided as part of the request. The web app retrieves characterization data corresponding to the identified mobile device from the database and processes the image and/or derived color/spectral values as normalized by the characterization data. The web app then delivers a viewing quality rating to the mobile app. In another embodiment, the mobile app makes a request to the database via the server for the characterization data corresponding to the mobile device on which it is running. The server returns the characterization data to the mobile app and the mobile app performs the step 16 of determining whether viewing quality is good.

If viewing quality is determined to be poor, lighting or other environmental factors may be adjusted and, in step 18, the workflow performed again. If viewing quality is determined to be good, the first workflow is completed. In some embodiments, the overall process is to next execute the second workflow, which is calibration.

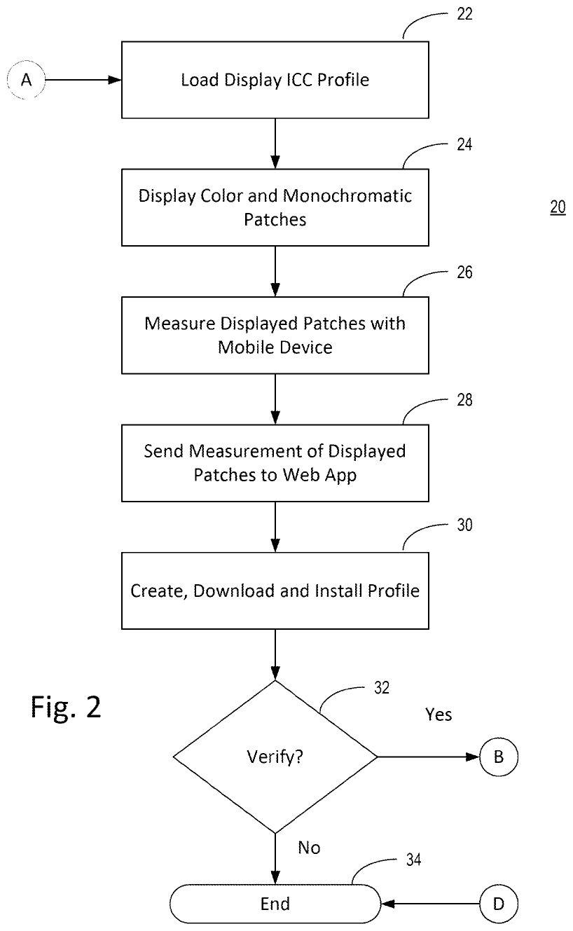

With reference to FIG. 2, in a second workflow 20, a calibration of a display device is performed. In a first step 22, the local app installed on a computing device, such as a personal computer, tablet, or as otherwise defined herein, loads a device profile, such as an ICC profile for a display associated with the computing device. A device profile describes the color space of an input or output device, in that it assigns to the device specific color vales (for example RGB or CMYK) absolute color values (XYZ or CIE Lab L*a*b*) according to the specifications of the CIE (Commission Internationale de I′Eclairage) or other not device specific color values (for example sRGB). A device profile typically consists of various color value replacement tables (lookup tables) and coefficients of a color space transformation matrix. The device profile is strongly dependent on the device calibration. In order to successfully carry out color management, it is therefore a prerequisite that the calibration of all input and output devices involved does not change. It must be kept in a constant condition by regular control and readjustment. The ICC profile may comprise any of the following: a profile provided by the display manufacturer, an Extended Dynamic Range profile, or a generic profile.

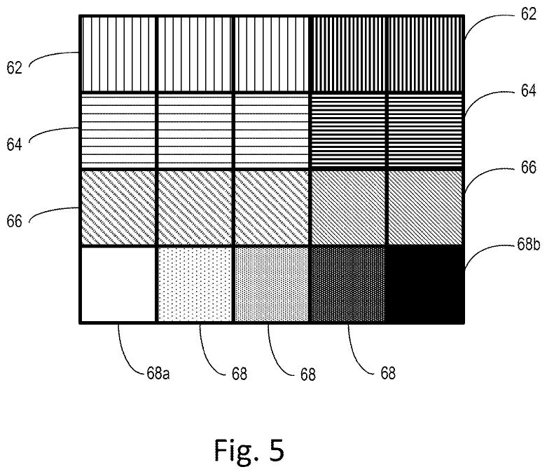

In a second step 24, the local app causes the display to display a plurality of predetermined calibration patches 60 (FIG. 5). In some embodiments, the calibration patches comprise color patches 62, 64, 66 and a plurality of grey scale patches 68. In some embodiments, the color patches comprise red patches 62, blue patches 64 and green patches 66. In some embodiments, for each of the colors displayed, a plurality of patches of the same hue are displayed at different levels of color saturation. For the grey scale patches 68, black 68b, white 68a and a plurality of grey patches 68 are displayed, with the grey patches displaying varying levels of lightness. Advantageously, the red, blue and green patches correspond to the red, blue and green pixels generating light on the display and receiving light on the image sensor of the mobile device.

In a third step 26, a measurement is made by the mobile device of the displayed calibration patches. In one example, an image of the displayed calibration patches is acquired using the mobile device. This may be performed by a user operating the mobile device, or automatically by the mobile device when the predetermined calibration patches are detected to be within the field of view of the mobile device's camera.

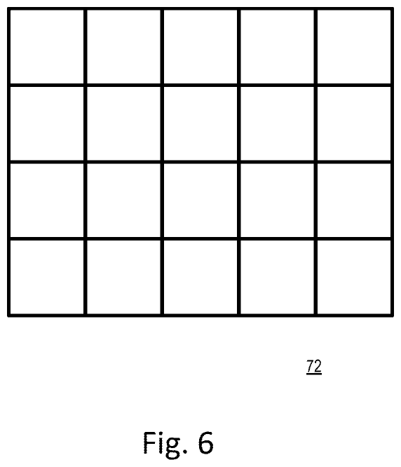

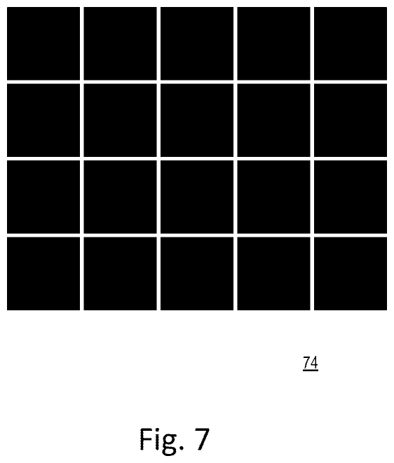

Displaying and measuring multiple patches on screen at the same time can greatly reduce measurement time and reduce potential errors due to movement of the camera during the measurement process. However, measuring multiple patches simultaneously makes non-uniformity of the screen, camera vignetting, and reflections off the screen into more significant problems. To reduce the severity of these problems, in some embodiments, the second step further comprises causing a set of white patches 72 to be displayed (FIG. 6), and a set of black patches 74 to be displayed (FIG. 7). In such embodiments, the third step further comprises acquiring an image of the displayed white patches on the mobile device and acquiring an image of the displayed black patches on the mobile device. The color and greyscale patches are also displayed and measured as set forth above.

The white patches are used to correct for non-uniformity of the screen as well as camera vignetting. The black patches are used to correct for reflections from the screen. Corrections from the three sets of measurements may be implemented as follows.

$${RGB}_{min} = ( Min ( {R}_{black} ) , Min ( {G}_{black} ) , Min ( {B}_{black} ) )$$

$${RGB}_{ColorCorrected} = Avg ( {RGB}_{White} - {RGB}_{min} ) * ( {RGB}_{Color} - {RGB}_{min} ) / ( {RGB}_{White} - {RGB}_{min} )$$

Where all RGB values are in linear RGB camera space, and
RGB_{black} are RGB measurements from the camera for the black patch set.
RGB_{white} are RGB measurements from the camera for the white patch set.
RGB_{Color} are RGB measurements from the camera for the color patch set.
Avg( ) is the average value across all patches in the set
RGB_{ColorCorrected} are corrected RGB measurements.

In a fourth step 28, the mobile device then transmits the measurement of the displayed calibration patches to the web app. In some embodiments, the image comprises the measurement. In a preferred embodiment, the mobile device processes the image according to the mobile device's characterization data retrieved from the database to determine displayed color values, and the color values are transmitted to the web app. Also, if a database was developed of the spectral emissivities of the display (collected during the Pantone Validated display process) that data may also be used for a more accurate characterization.

In a fifth step 30, the web app creates an ICC profile for the display based on the color values that the display rendered as measured by the mobile device. The web app then downloads the profile to the application on the computing device, which installs the profile.

In a sixth step 32, a decision is made whether to verify the calibration. If the decision is no, the process is completed 34. If the decision is yes, then the overall process continues with the third workflow, verification.

In some embodiments, a user interacts with the local computer and the mobile device to cause one or more sets of calibration patches to be displayed, and also interacts with the mobile device to cause the mobile device to acquire an image of the displayed calibration patches. In some embodiments, the mobile app establishes communication with the local app over networking hardware of the mobile device and local computer, respectively. The mobile app can then cause the local app to display a sequence of calibration patches on the display device and, when a particular set of calibration patches are within the field of view of the camera on the mobile device, automatically acquire an image of the displayed patches. The mobile app may be configured to recognize the calibration patches themselves or marks such as Aruco marks.

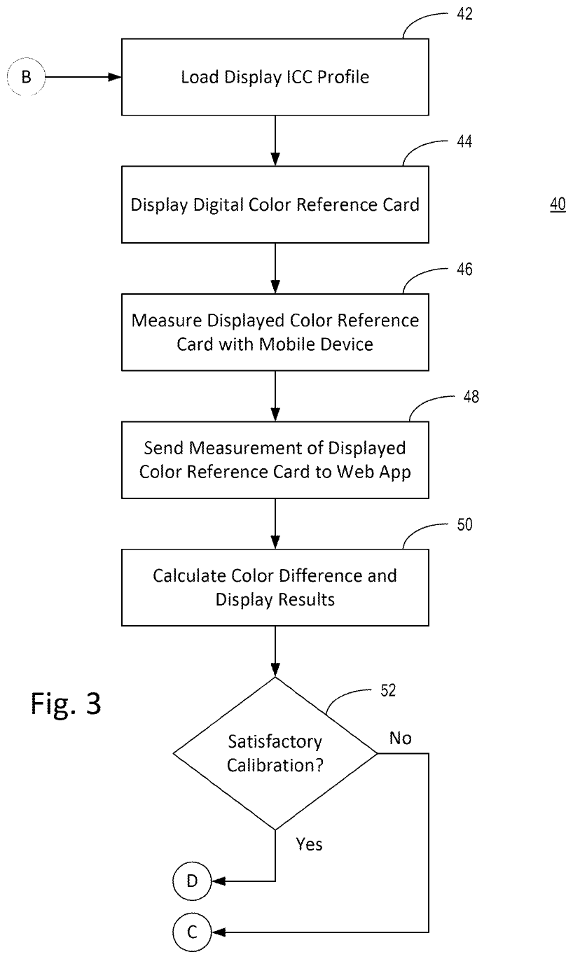

With reference to FIG. 3, in a third workflow 40, a verification of a calibration is performed. In a first step 42 of the third workflow, the local app on the computing device loads the ICC profile created in the second workflow for the display to be verified. In a second step 44, the application then causes the display to display a digital version of the color reference card. In this workflow, color patches on the color reference card are not used for calibration, but instead for validation of a calibrated display device. In a third step 46, the displayed digital color reference card is measured with the mobile device using the mobile app. In a fourth step 48, the measurements of the digital color reference card are transmitted to the web app. In a fifth step 50, the web app calculates color differences and returns results to the computer application, which displays the results. A decision is then made as to whether the calibration is satisfactory in step 52. If no, the process may return to the first workflow or to the second workflow. If yes, the process is concluded.

Embodiments within the scope of the present disclosure include physical and other computer-readable media for carrying or storing computer-executable instructions and/or data structures. In particular, one or more of the processes or methods described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes or methods, including one or more of the processes or methods described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A digital communication interface, or network, is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface card or module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in part in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

1. A system of calibrating a display associated with a computing device, comprising:
a mobile app installed on a mobile device comprising a camera, a processor, non-volatile storage, and communication means;
a web app installed on a network accessible computer server; and
a local app installed on the computing device;
wherein the mobile app comprises computer-readable instructions stored in the non-volatile storage that, when executed by the processor, cause the mobile device to:
process an image taken of the display to determine color values of calibration patches displayed on the display; and
transmit the color values to the web app;
wherein the web app comprises a database of mobile device characterization data and computer-readable instructions that, when executed by the network accessible server, cause the server to:
receive color values transmitted by the mobile app;
process the color values to create a calibrated device profile for the display; and
download the calibrated device profile to the local app on the computing device; and
wherein the local app comprises computer-readable instructions that, when executed by a processor on the computing device, cause the computing device to:
display calibration patches;
receive the calibrated device profile from the web app; and
install the calibrated device profile;
wherein the calibration patches comprise a plurality of red patches displayed at different levels of color saturation, a plurality of green patches displayed at different levels of color saturation, and a plurality of blue patches displayed at different levels of color saturation.

2. The system according to claim 1, wherein
the local app further comprises instructions which cause the computing device to display a digital color reference card on the display after installation of the calibrated device profile;
wherein the mobile app further comprises instructions which cause the mobile device to acquire an image of the displayed digital color reference card and send the image to the web app; and
wherein the web app further comprises instructions to calculate color differences between the displayed color reference card and reference color information to validate the calibrated device profile.

3. The system according to claim 1, further comprising a physical color reference card, wherein the mobile app further comprises instructions that, when executed, cause the processor to process an image taken of the color reference card and determine a quality of viewing conditions.

4. The system according to claim 1 wherein the mobile app further comprises instructions that, when executed, cause the processor to retrieve camera calibration information specific to the mobile device from the web app.

5. The system according to claim 1 wherein the local app further comprises instructions to load a predetermined device profile prior to displaying the calibration patches.

6. The system according to claim 5 wherein the predetermined device profile is a generic ICC profile.

7. The system according to claim 5 wherein the predetermined device profile is a manufacturer's ICC profile specific to the model of device display being calibrated.

8. The system according to claim 1 wherein the calibration patches further comprise grey scale patches.

9. The system according to claim 8, wherein the calibration patches consist essentially of the plurality of red patches displayed at different levels of color saturation, the plurality of green patches displayed at different levels of color saturation, the plurality of blue patches displayed at different levels of color saturation, and the grey scale patches.

10. The system according to claim 1 wherein the calibration patches further comprise a set of white patches and a set of black patches;
wherein the mobile app comprises computer-readable instructions that, when executed by the processor, cause the mobile device to process an image of the white patches, an image of the black patches, and an image of the red, green and blue patches taken of the display to determine display uniformity, reflectance data, and color values of the red, green, and blue patches displayed on the display, respectively.

11. A method of calibrating a display associated with a computing device, comprising:
displaying calibration patches on the display associated with the computing device, the calibration patches comprising a plurality of red patches displayed at different levels of color saturation, a plurality of green patches displayed at different levels of color saturation, and a plurality of blue patches displayed at different levels of color saturation;
acquiring an image of the displayed calibration patches;
processing the image to determine color values of the displayed calibration patches; and
processing the color values to create a calibrated device profile for the display; and
installing the calibrated device profile on the computing device.

12. The method according to claim 11, further comprising the steps of:
displaying a digital color reference card on the display after installing the calibrated device profile;
acquiring an image of the displayed digital color reference card; and
calculating color differences between the displayed color reference card and reference color information to validate the calibrated device profile.
